(19) United States
(12) Patent Application Publication
(10) Pub. No.: US 2021/0108645 A1
(43) Pub. Date: Apr. 15, 2021

(54) VEHICLE AIR FLOW CONTROL SYSTEM

(71) Applicant: International Engine Intellectual Property Company, LLC, Lisle, IL (US)

(72) Inventor: Martin Wayne Dirker, Aurora, IL (US)

(21) Appl. No.: 16/598,872

(22) Filed: Oct. 10, 2019

(51) Int. Cl. F04D 23/00; F01P 1/06; F04D 29/58; B62D 25/12; B60K 11/08

(52) U.S. Cl. CPC F04D 23/001; F01P 1/06; B60K 11/08; B62D 25/12; F04D 29/5833

(57) ABSTRACT

An air flow control system for use with a vehicle including a hood, a grille and a heat exchanger comprises a shaft having an axis of rotation disposed behind the grille and in front of the heat exchanger. The axis of rotation is perpendicular to a direction of air flow from the grille to the heat exchanger. A blade is mounted to the shaft. A mover is operatively connected with the shaft to rotate the shaft about the axis of rotation thereby moving the blade between a first position where air is permitted to flow from the grille to the heat exchanger, and a second position air is restricted from flowing from the grille to the heat exchanger.

### BACKGROUND

Embodiments disclosed herein relate generally to a vehicle air flow control system. Specifically, embodiments disclosed herein relate to an air flow control system used with an engine including a heat exchanger.

It is well known to control air flow in a vehicle, such as a commercial class 8 tractor that pulls a trailer. Some of these air flow control systems comprise active shutters disposed at a front of the tractor. In these air flow control systems, the shutters pivot along an axis perpendicularly to a direction of air flow, i.e. vertically, between an open position, where air flow is allowed through the shutters, and a closed position, where air flow is restricted through the shutters. It is desirable to provide an improvement to air flow control systems.

### SUMMARY

Disclosed herein are embodiments of a vehicle air flow control system.

According to one embodiment, the system has a hood, a grille and a heat exchanger. The air flow control system comprises a shaft having an axis of rotation disposed behind the grille and in front of the heat exchanger. The axis of rotation is perpendicular to a direction of air flow from the grille to the heat exchanger. A blade is mounted to the shaft. A mover is operatively connected with the shaft to rotate the shaft about the axis of rotation thereby moving the blade between a first position where air is permitted to flow from the grille to the heat exchanger, and a second position air is restricted from flowing from the grille to the heat exchanger.

### DESCRIPTION OF THE DRAWINGS

FIG. 1 is an elevational view of an embodiment of an air flow control system located inside an engine compartment of a vehicle described herein;

FIG. 2 is an enlarged view of a portion of the air flow control system of FIG. 1 in an open position;

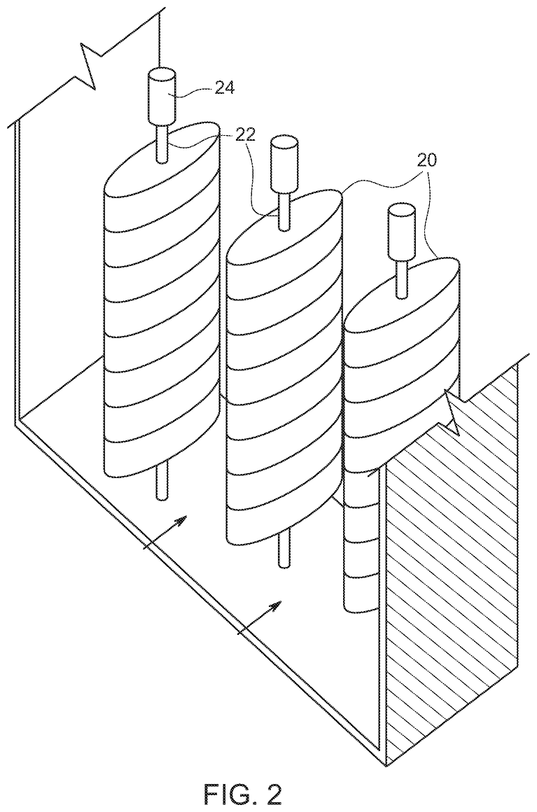

FIG. 3 is an enlarged view of a portion of the air flow control system of FIG. 2, showing in dotted lines, a closed position of the air flow control system; and

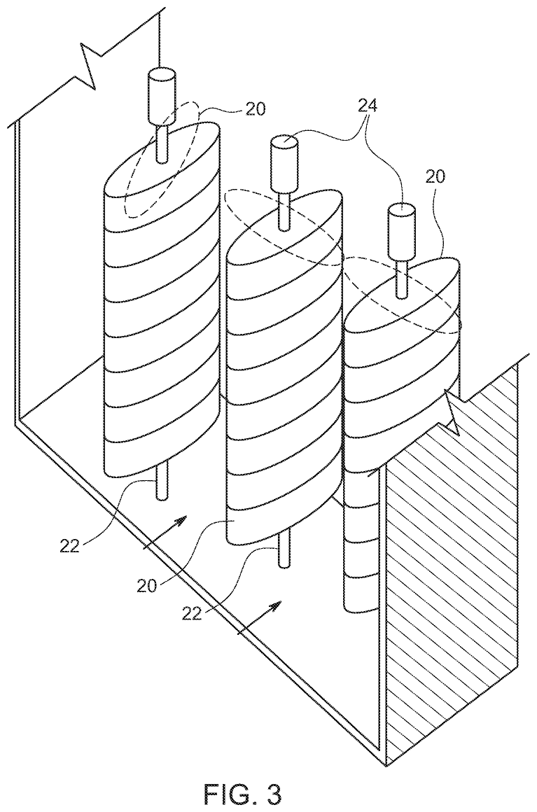

FIG. 4 is a schematic representation of a portion of a vehicle having an air flow control system.

### DETAILED DESCRIPTION

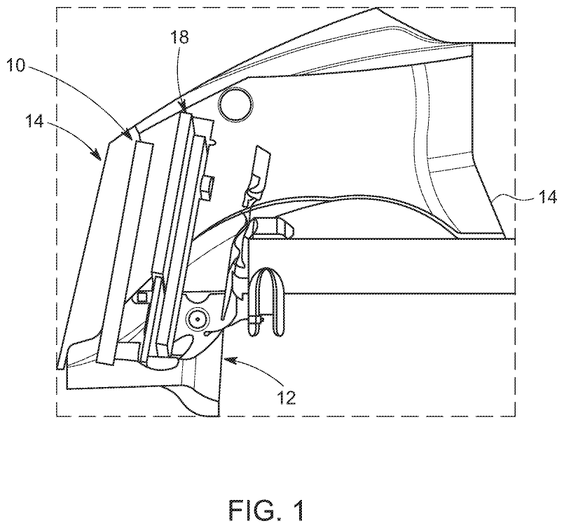

This disclosure relates to a vehicle air flow control system 10 shown in an engine compartment 12 of a vehicle 14. As shown in FIG. 1, the vehicle air flow control system 10 is disposed in the engine compartment 12 behind a grille 16 and in front of a heat exchanger 18. The grille 16 obstructs view of the air flow control system 10 from a front of the grille 16.

As is described in greater detail herein, air flows through the grille 16 and encounters the air flow control system 10. The air flow control system 10 moves between a first or open position and a second or closed position. In the open position, the air flow control system 10 permits air to flow from the grille 16 to the heat exchanger 18 where heat is transferred from the heat exchanger 18 to the air. In the closed position, the air flow control system 10 restricts air flow from the grille 16 to the heat exchanger 18. Also, in the closed position, the air flow control system 10 can increase aerodynamic performance of the vehicle 14 by reducing drag.

In one embodiment, the air flow control system 10 comprises at least one blade 20. Sometimes, the blade 20 comprises an injection molded plastic. The blade 20 is mounted on a shaft 22. The shaft 22 has an axis of rotation disposed on the vehicle 14. The axis of rotation of the shaft 22 is perpendicular to a direction of air flow from the grille 16 to the heat exchanger 18. One end of the shaft 22 is operatively connected to a mover 24, such as an electric motor, a gear, a pulley, a belt and the like. The mover 24 moves or rotates the shaft 22 axially, thereby moving the blade 20 between an open position, permitting air to flow from the grille 16 to the heat exchanger 18, and a closed position, restricting air flow from the grille 16 to the heat exchanger 18. The mover 24 is connected to a controller, not shown for clarity, that determines when the motor 24 moves the shaft 22 and the associated blade 20 between the open position and the closed position. It is possible, for instance when it is not necessary to permit air to flow from the grille 16 to the heat exchanger 18, i.e. ambient temperature is reduced or cooling demand is reduced, the blade 20 is moved to the closed position, thereby restricting air flow from the grille 16 to the heat exchanger 18 and thus reducing drag of the vehicle 14. Alternatively, when ambient temperature is for when cooling demand is increased, the blade 20 is moved to the open position, thereby permitting air flow from the grille 16 to the heat exchanger 18.

In some embodiments, the motor 24 may move the shaft 22 and the associated blade 20 to a third position between the first position and the second position. The motor 24 may allow the shaft 22 and the associated blade 20 to remain in the third position.

In some embodiments, the air flow control system 10 comprises a plurality of blades 20, each blade 20 being mounted on its own shaft 22. Each shaft 22 is connected with a mover 24. The number of movers 24 may be equal to or smaller than the number of shafts 22. Sometimes, a first group of shafts 22 and associated blades 20 are connected together, such as by a first belt and the like. A second group of shafts 22 and associated blades 20 are connected together, such as by a second belt and the like. If desired, the controller moves the first group of shafts 22 independently from the second group of shafts 22. In this manner, a first group of blades 20 can be moved to a first one of the open position and the second position, and a second group of blades 20 can be moved a second one of the open position and the second position. By doing this, it is possible to control variably, flow of air from the grille 16 to the heat exchanger 18.

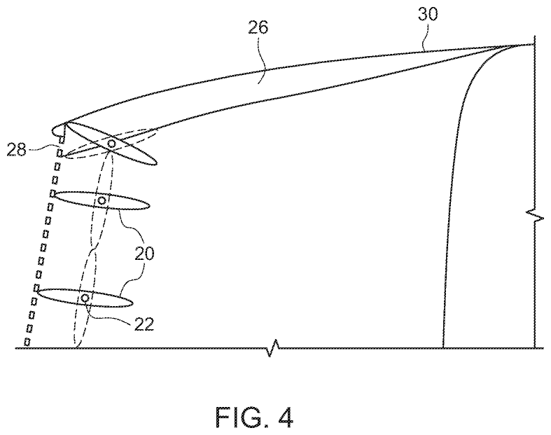

In other embodiments, the vehicle 14 includes a duct 26 disposed adjacent a hood of the vehicle 14, as shown in FIG. 4. A blade 20 and associated shaft 22 are located at an entrance 28 of the duct 26. At an end of the duct 26 opposite to an end thereof adjacent the entrance 28 there is disposed an exit 30 that allows air flow to pass out of the duct 26. A controller, not shown for clarity, and a mover 24 are connected with the associated shaft 22. This blade 20 moves between an open position, where air flow through the entrance 28 is permitted, and a closed position, where air flow through the entrance 28 is restricted. In other embodiments, the entrance 28 is not obstructed. When air flow through the entrance 28 is restricted, heat exchanger 18 receives additional air flow. FIG. 4 shows blades 20 of the air flow control system 10 in a second position, restricting air flow from the grille 16 to the heat exchanger 18. In this state, air flow is directed to the entrance 28 of the duct 26. Air passes from the entrance 28 along the duct 26 and leaves the duct 26 through the exit 30. Also, air flow may be directed over a top of the hood of the vehicle 14.

Any of the embodiments described herein can regulate air flow to the heat exchanger 18, increase vehicle 14 fuel economy by only cooling as much as is needed and allowing maximum bypass air when cruising.

What is claimed is:

1. An air flow control system for use with a vehicle including a hood, a grille and a heat exchanger, the air flow control system comprising:
a shaft having an axis of rotation disposed behind the grille and in front of the heat exchanger, the axis of rotation is perpendicular to a direction of air flow from the grille to the heat exchanger;
a blade mounted to the shaft; and
a mover operatively connected with the shaft to rotate the shaft about the axis of rotation thereby moving the blade between a first position where air is permitted to flow from the grille to the heat exchanger, and a second position where air is restricted from flowing from the grille to the heat exchanger.

2. The air flow control system as defined in claim 1 further comprising
a duct disposed adjacent the hood of the vehicle;
an entrance disposed at one end of the duct that allows air to flow into the duct; and
an exit disposed at an end of the duct opposite to the entrance to allow air to flow out of the duct.

3. The air flow system as defined in claim 1 wherein the blade comprises an injection molded plastic.

4. The air flow system as defied in claim 1 further comprising:
the mover moving the blade and the shaft to a third position between the first position and the second position.
